(19) United States
(12) Patent Application Publication
(10) Pub. No.: US 2011/0290374 A1
(43) Pub. Date: Dec. 1, 2011

(54) FILLING SYSTEM

(75) Inventor: Ludwig Clüsserath, Bad Kreuznach (DE)

(73) Assignee: KHS GmbH, Dortmund (DE)

(21) Appl. No.: 13/144,977

(22) PCT Filed: Mar. 17, 2010
(86) PCT No.: PCT/EP2010/001677

§ 371 Date: Jul. 18, 2011

(30) Foreign Application Priority Data
Apr. 6, 2009 (DE) 10 2009 016 322.0

(51) Int. Cl. B67C 3/06

(52) U.S. Cl. 141/67

(57) ABSTRACT

The invention relates to a filling system for filling bottles or similar containers (2) with a liquid filling material, said system comprising at least one filling element, a liquid channel formed in a housing of the filling element and connected to a tank for providing the liquid filling material, and at least one outlet for dispensing the liquid filling material into the respective container attached to the filling element. Said filling system also comprises a liquid valve in the liquid channel, a gas return tube that projects past the at least one outlet on one end, for controlling the level of the filling material in the filled container, and is connected to a gas chamber, formed for example in the tank, by means of a fluid connection. The filling system also comprises an open fluid channel inside the filling element, in the region of the outlet. Said channel can be connected to a ring channel guiding a gaseous and/or vaporous fluid under pressure, preferably an inert gas under pressure, and controlled by at least one first control valve.

The invention relates to a filling system for filling containers with a liquid filling material.

A filling system with the features of the preamble of claim 1 is known and is suitable in particular for filling bottles or other containers in a normal pressure filling method in which the container concerned, before the start of the actual filling (filling phase), is pressed with its container opening in a tight seal against the respective filling element and then with the container still sealed against the filling element, the actual filling phase is begun by opening a liquid valve. In the filling phase the gas and/or vapour medium expelled from the interior of the container due to the filling material flowing in, for example air or an inert gas resulting from a previous rinsing e.g. CO2 gas, flows via the return gas pipe extending into the container into a gas chamber of a tank which is provided common to all filling elements of the filling system and is partly filled with the liquid filling material. The flow of the liquid filling material into the container concerned is ended after immersion of the lower end of the return gas pipe determining the filling height in the rising level of filling material in the container when an equilibrium is created between the geodetic filling material pressure determined by the level of the filling material in the tank and the filling material or liquid column formed in the return gas pipe and/or fluid channel internal to the filler element at the end of filling. In a subsequent so-called Trinox method, by pressurising the fluid channel internal to the filling element with a pressurised gaseous and/or vaporized fluid, for example an inert gas under pressure e.g. CO2 gas, the liquid filling material from the fluid channel internal to the filling element is returned out of a head space formed above the lower end of the filling pipe in the container and out of the return gas pipe into the tank so that at the end of this Trinox method, the filling level in the container concerned lies slightly (for example 2 to 5 mm) below the lower end or lower opening of the return gas pipe. This filling system is characterised by a simple and reliable construction.

The object of the invention is to improve the filling system of the generic type so that while retaining the basic advantages of the known filling system, pressurised or positive pressure filling of containers is possible. To achieve this object a filling system is formed according to claim 1.

The filling system according to the invention is suitable amongst others for positive pressure filling, in particular for pressurised filling, wherein the container concerned is not only prestressed with an inert gas but before prestressing is flushed with the inert gas and wherein furthermore the precise setting of the fill level takes place using the Trinox method. For this the filling system according to the invention requires merely one additional control valve per filling element, namely in the fluid connection of the return gas pipe with the gas chamber which on pressure filling receives the return gas expelled from the interior of the container. This gas chamber is preferably the same gas chamber which is formed above the filling material level in the tank providing the filling material.

Refinements, advantages and possible applications of the invention arise from the description below of embodiment examples and the figures. All features described and/or shown in the figures belong to the object of the invention, alone or in any combination, irrespective of their summary in the claims or back reference. The content of the claims is also part of the description.

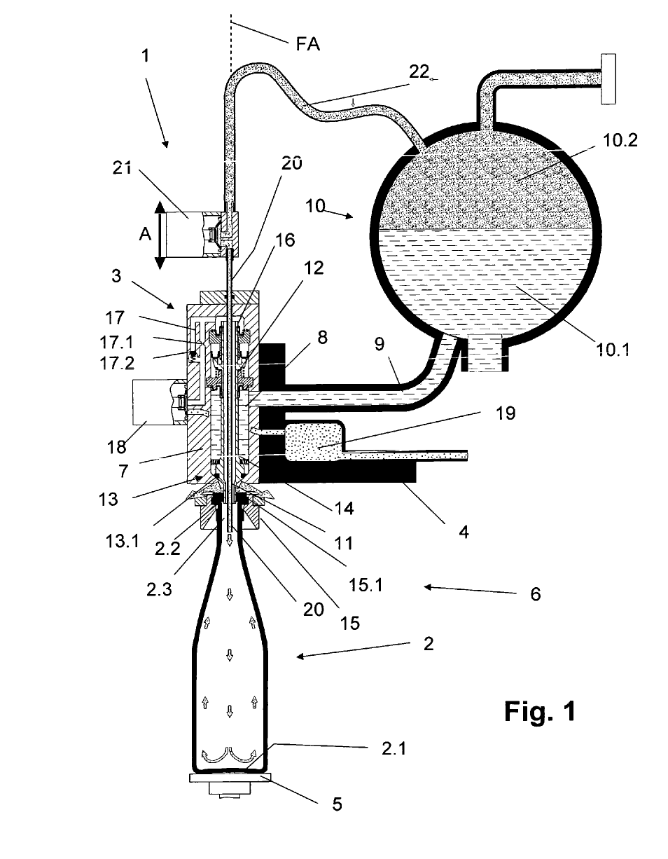

The invention is explained in more detail below with reference to FIGS. 1 to 5, each of which show a filling element of a filling system of a machine of current design in simplified view and in cross section together with a bottle in various phases of the filling process.

The filling system designated generally as 1 in the figures serves to fill containers in the form of bottles 2 with a liquid filling material and comprises amongst others a filling element 3 which is fitted with a multiplicity of identically designed filling elements 3 on the periphery of a rotor 4 which can be driven in circulation about a vertical machine axis. A container carrier 5 is allocated to each filling element 3 which in the embodiment shown is designed as a bottle plate and on which during the filling process the bottle 2 stands with the bottle base 2.1 with its bottle axis oriented in the horizontal direction, i.e. in the filling element axis FA. The filling element 3 which together with its container carrier 5 constitutes a filling position 6, has in a filling element housing 7 a fluid channel 8 which via a product line 9 is connected with a tank 10 common to all filling elements 3 of the filling system 1 or filling machine and provided on the rotor 4, and on the underside of the filling element forms an outlet 11 to discharge the liquid filling material to the bottle 2 at the filling position 6.

During the filling process the tank 10 is partly filled with liquid filling material to a controlled level such that in the tank 10 is formed a fluid chamber 10.1 filled by the filling material and above this a gas chamber 10.2 which on pressure filling is filled pressure-controlled with the pressure of an inert gas, for example a CO2 gas.

In the fluid channel 8 is provided the liquid valve 13 which can be controlled by a control device 12 and essentially comprises a valve body 13.1 formed by a tube 14. The tube 14 open at both ends and coaxial with a vertical filling element axis FA protrudes through the output opening 11 over the underside of the filling element 3 or a ring seal 15.1 provided there in a centring sleeve 15, and opens with its upper open end in a chamber 16 which is part of a system of gas ways formed in the filling element housing 7 and designated in the figures generally as 17 and via which the chamber 16 and hence also a fluid channel formed inside the tube 14 internal to the filling element can also be connected in a manner described in more detail below, controlled via a control valve 18, with a ring channel 19 which is provided common to all filling elements 3 on the rotor 4 and during the filling process carries an inert gas for example a CO2 gas under a pressure which is greater than the pressure in the gas chamber 10.2.

Each filling element 3 furthermore comprises a return gas pipe 20 determining a filling height which is arranged coaxial with the filling element FA and from above passes, sealed by the filling element housing 7, through the chamber 16, through the tube 14 and with its lower end or the opening there protrudes above the lower end of the tube 14. The upper end of the return gas pipe 20 is connected via a control valve 21 and a flexible line 22 with the gas chamber 10.2 of the tank 10.

The return gas pipe 20 determines the fill level achieved at the end of the filling process in the bottle concerned with the Trinox method described below in more detail. To adjust the fill height the return gas pipes 20 of all filling elements 3 can for example be adjusted by a central adjustment device in the respective filling element axis FA as indicated by double arrow A.

The special feature of the filling system 1 lies in the additional control valve 21 in the connection between the return gas pipe 20 and the gas chamber 10.2. With the filling system with the filling elements 3 and/or with the corresponding filling machine, various filling methods are possible so that for example pressure or positive pressure filling is possible with the method steps shown in FIGS. 1 to 5 and described below, where in these method steps the liquid valve 13 and control valves 18 and 21 are each in their closed position as long as the open position is not expressly specified.

1. Flushing the Bottle 2 with Inert Gas (FIG. 1)

After delivering the bottle 2 to a filling position 6, this bottle is raised against the filling element 3 concerned, for example only so far that a gap remains between the bottle opening 2.2 and the seal 15.1. By opening the control valve 21 inert gas is introduced from the gas chamber 10.2 via the return gas pipe 20 to flush the bottle 2. Air existing in the bottle 2 and then increasingly inert gas is dissipated via the gap between the bottle opening 2.2 and the seal 15.1.

Evidently the dissipation of air and inert gas during flushing can also take place via a gas channel formed in the respective filling element housing 7 so that the bottle 2 even during flushing lies pressed with its bottle opening 2.2 sealed against the filling element 3 or against the seal 15.1.

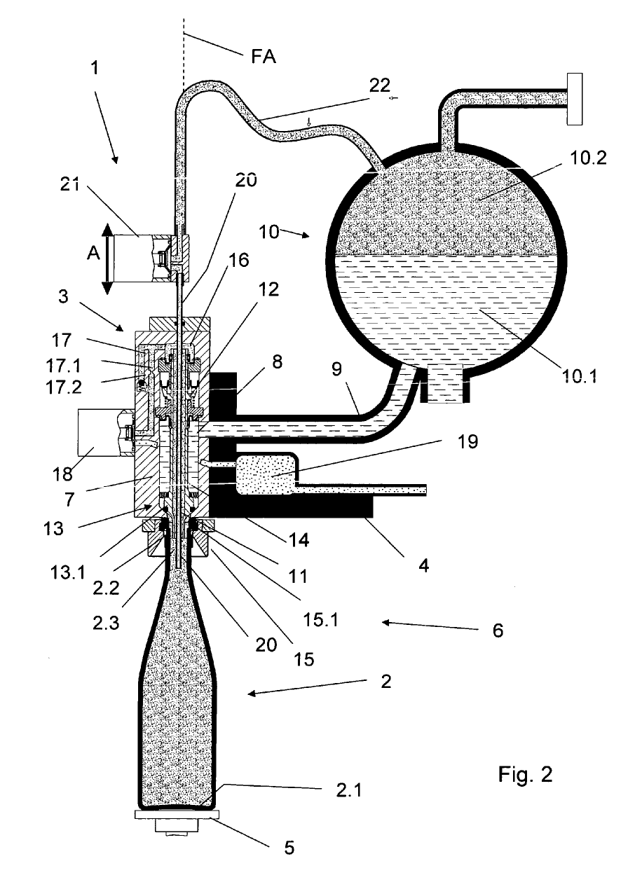

### 2. Prestressing the Bottle 2 (FIG. 2)

With the bottle 2 sealed against the filling element 3, by opening the control valve 21 the interior of the bottle 2 is prestressed via this control valve and the return gas pipe 20 with a pressurised inert gas from the gas chamber 10.2.

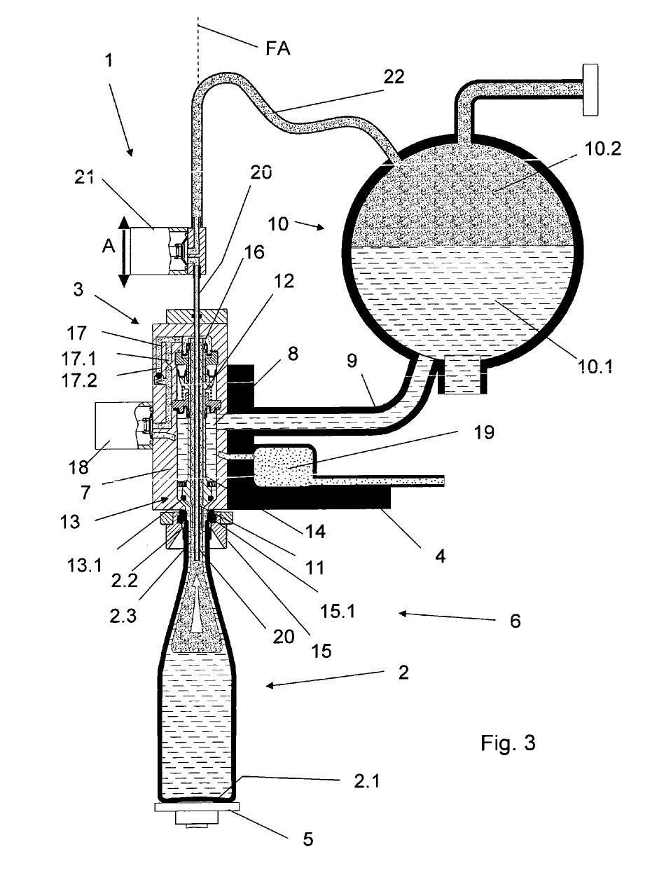

### 3. Filling the Bottle 2 (FIG. 3)

With the bottle 2 still sealed against the filling element 3, with the control valve 21 open the liquid valve 13 is opened so that the liquid filling material can flow via the outlet opening 11 into the bottle 2. The inert gas expelled by the liquid filling material from the interior of the bottle, at least in the end phase of filling, is expelled solely via the return gas pipe 20 and the opened control valve 21 into the gas chamber 10.2.

The flow of the liquid filling material into the bottle 2 automatically ends while the liquid valve 13 is still open when after immersion of the lower end or the opening there of the return gas pipe 20 into the level of the filling material in the bottle 2, this filling material has risen both in the return gas pipe 20 and in the tube 14 so far that equilibrium exists between the filling material column concerned in the return gas pipe 20 or in the tube 14 and the geodetic pressure of the filling material in the tank 10.

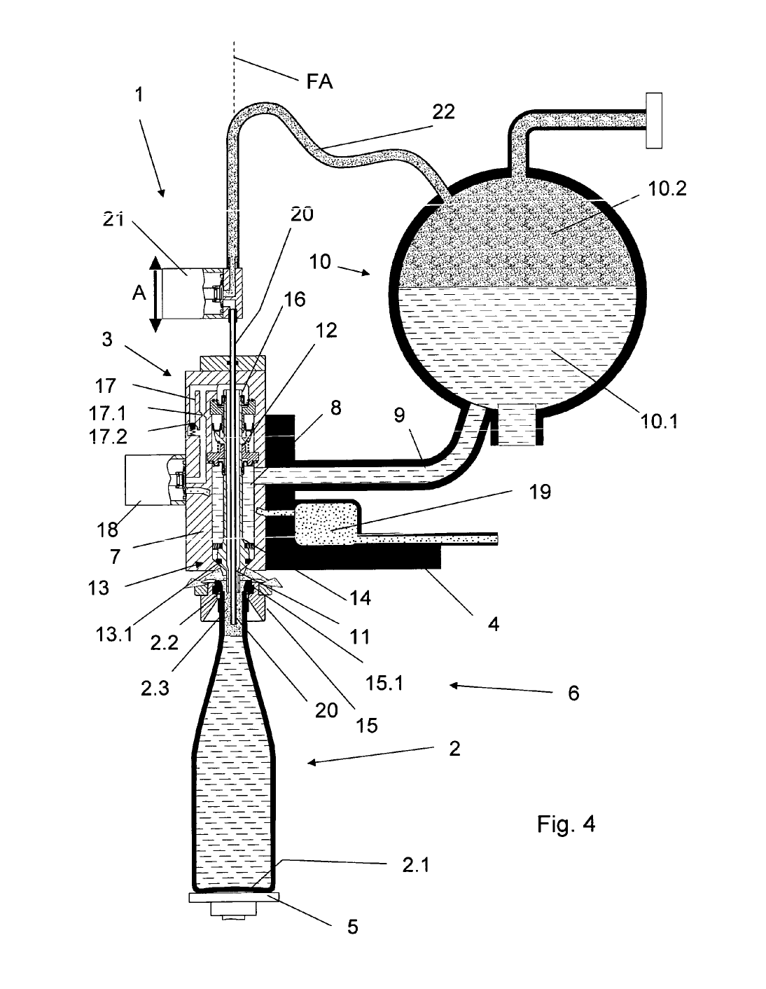

### 4. End of Filling and Adjustment of Precise Filling Height (FIG. 4)

To adjust the precise filling height and return the filling material from the tube 14 and the return gas pipe 20, and from the head space 2.3 of the bottle 2 above the lower end of the return gas pipe 20, with the liquid valve 13 closed and the control valve 21 open, control valve 18 is opened so that with inert gas under pressure from the Trinox or ring channel 19, the filling material from the tube 14 and/or the fluid channel internal to the filling element and the head space 2.3 of the bottle 2 and from the return gas pipe 20 is returned into the tank 10 until the level of the liquid filling material within the bottle is approximately 2 to 5 mm below the lower end of the return gas pipe 20. The chamber 16 and also the tube 14 and the fluid channel provided internal to the filling element are connected with the ring channel 19 via the open control valve 18 via a choke 17.1 provided in the gas way.

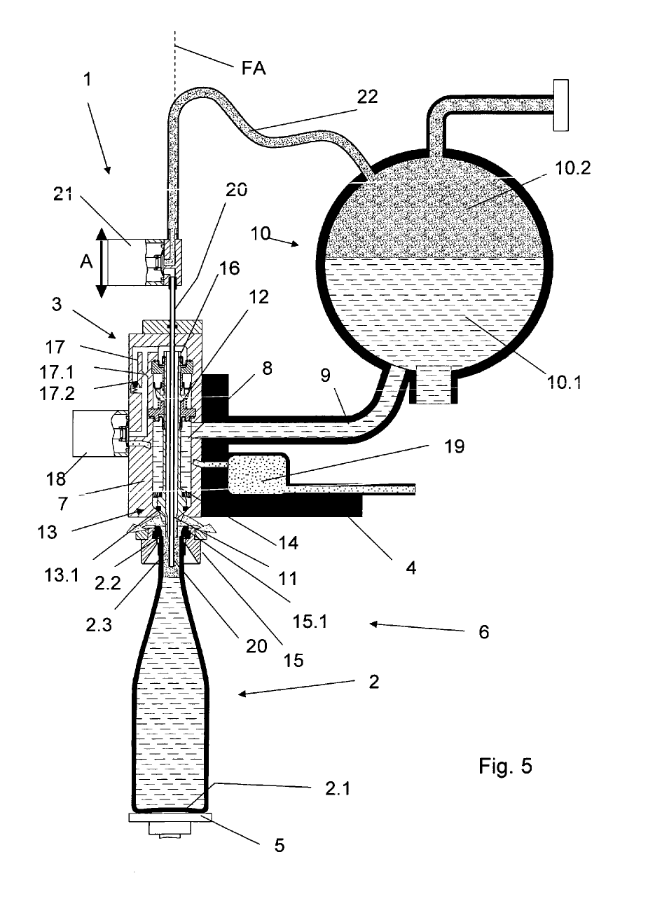

### 5. Lowering and Relieving the Bottle 2 (FIG. 5)

After the precise adjustment of the filling level and drainage of the return gas pipe 20, the bottle is lowered and relieved with the control valves 18 and 21 closed and liquid valve 13 closed, by controlled lowering of the container carrier 5. After completion of the Trinox method, the lower end of the return gas pipe 20 lies approximately 2 to 5 mm above the level of the filling material in the bottle 2.

With the filling system 1 not only is the positive pressure filling of the bottle 2 described above possible but also normal pressure filling and in particular normal pressure filling with adjustment of the precise fill level using the Trinox method. For this normal pressure filling, the gas chamber 10.2 of the partly filled tank 10 is admittedly for example again filled with inert gas but with inert gas under normal or atmospheric pressure. The filling of the bottle 2 then takes place with the control valve 21 permanently open such that the bottle 2 is first pressed against the filling element 3 with a seal and then to initiate the filling phase the liquid valve 13 is opened and then, after closing of the liquid valve 13, the control valve 18 is opened again to adjust the precise fill level with the Trinox method.

Due to the additional control valve 21 the filling system 1 is suitable for the positive pressure filling described above without great complexity. The particular advantages of the filling system 1 are therefore:

The filling system offers the possibility for both normal pressure filling and positive pressure filling.

Despite the possibility of adjusting the fill level for all filling elements together, for example automatically, and despite the integral Trinox filling level correction or adjustment for precise filling levels, the filling system is produced with only two control valves 18 and 19, for example controlled pneumatically, per filling element 3 i.e. with a simplified principle in both design and in control yet with a high filling comfort.

In addition to the tank 10, in the simplest case only one further gas channel is required for all filling elements 3, namely the ring channel 19 on the rotor. The ring channel 19 can also be used for CIP cleaning of the filling machine. For this a non-return valve 17.2 is provided in the gas way 17 concerned parallel to choke 17.1.

Furthermore the present invention also extends to a method in which the container or the bottle is withdrawn from the filling element without the prior relief phase i.e. under positive pressure.

This filling method according to the invention is possible firstly because due to the prior precise adjustment of the filling level by the Trinox method, a distance of approximately 2 to 5 mm remains between the filling material level and the lower end of the return gas pipe 20. Secondly the filling method is possible because in the flexible line 22 between the return gas pipe 20 and the gas chamber 10.2 of the tank 10 is provided a control valve 21 with which the connection can be interrupted.

The distance between the lower end of the return gas pipe 20 and the filling material level constitutes an open gas connection between the head space of the bottle and the return gas pipe.

Before lowering the bottle the control valve 21 is closed, securely preventing a further flow of pressurised gas from the tank 10. If now the bottle is withdrawn from the filling valve seal, automatically the gas volume existing inside the return gas pipe expands wherein a gas or pressure pulse is formed directed towards the end of the return gas pipe 20.

As however the lower end of the return gas pipe 20 is arranged spaced above the filling material level, the gas or pressure pulse emerging from the return gas pipe 20 and directed onto the filling material only has a restricted minimal effect as there are substantial expansion or diffusion losses on its emergence from the return gas pipe.

Finally the procedure described above allows a clear reduction in undesirable foaming of the filling material. At the same time the otherwise normal pressure release valve can be omitted.

### LIST OF REFERENCE NUMERALS

1 Filling system
2 Bottle
2.1 Bottle base
2.2 Bottle opening
2.3 Head space
3 Filling element
4 Rotor
5 Container carrier
6 Filling position
7 Filling element housing
8 Fluid channel 9
9 Product line
10 Tank
10.1 Fluid chamber
10.2 Gas chamber
11 Outlet opening
12 Control device
13 Liquid valve
13.1 Valve body
14 Gas pipe
15 Centring sleeve
15.1 Seal
16 Chamber
17 Gas channel
17.1 Choke
17.2 Non-return valve
18 Control valve
19 Ring channel
20 Return gas pipe
21 Control valve
22 Flexible line
FA Filling element axis
A Filling height adjustment

1. A filling system for filling containers with a liquid filling material, said filling system comprising:
at least one filling element having a housing, said filling element including
a fluid channel formed in the housing, said fluid channel being connected to a tank for providing the liquid filling material,
at least one outlet to discharge the liquid filling material into a container provided at the filling element,
a liquid valve in the fluid channel,
a fluid channel internal to the filling element and open in an area of the at least one outlet,
at least one first control valve for selectively connecting said fluid channel internal to the filling element with a ring channel carrying a pressurized gas;
a return gas pipe for controlling an extent to which said container is filled by said liquid filling material, said return gas pipe having a first end that protrudes over the at least one outlet and that connects, via a fluid connection, to a gas chamber; and
at least one second control valve for controlled opening and closing of the fluid connection between the return gas pipe and the gas chamber.

2. The filling system of claim 1, wherein at least one of the first control valve and the second control valve is a pneumatically activated valve.

3. The filling system of claim 1, wherein the fluid channel internal to the filling element is formed at least in part on a part length of a ring channel surrounding the return gas pipe in a tube.

4. The filling system of claim 1, wherein the filling element in the area of the at least one outlet comprises a contact surface surrounding the outlet, said contact surface sealing a mouth of said container during at least one phase of a filling process.

5. The filling system of claim 1, wherein the return gas pipe includes a second end that protrudes through the at least one outlet and the contact surface out of the filling element or filling element housing.

6. The filling system of claim 1, wherein the fluid channel internal to the filling element comprises a pipe that protrudes with an open end through the at least one outlet out of the filling element or filling element housing.

7. The filling system of claim 1, wherein the return gas pipe is axially mobile to adjust the filling height of the container.

8. The filling system of claim 1,
wherein the second control valve is configured to be opened prior to initiation of a filling phase to flush and pre-stress the interior of a container lying sealed against the filling element using a pressurized inert gas delivered from the gas chamber via the return gas pipe and
the liquid valve is configured to be opened to allow liquid into the flushed and pre-stressed interior of the container,
whereby the filling system achieves positive pressure filling of the container.

9. The filling system of claim 1,
wherein the at least one control valve is configured to be opened for adjustment of an extent to which a container lying sealed with the filling element is to be filled; and
wherein the second control valve is configured to be opened to expel liquid filling material from at least out of a head space formed in the container above an end of the return gas pipe that extends into the container, thereby determining the fill height of the container.

10. A filling system for filling containers, said filling system comprising:
a rotor that can be driven to rotate about a vertical machine axis, and
a multiplicity of filling elements as recited in claim 1, said filling elements being mounted on said rotor.

11. A method for operating the filling system of claim 1, said method comprising
closing the second control valve after the end of a filling phase, and
adjusting the filling height with the Trinox method, and
without a prior relief phase, withdrawing the container under positive pressure from the filling element.

12. The filling system of claim 1, wherein said gas chamber is formed in said tank.

13. The filling system of claim 3, wherein the tube and the return gas pipe are coaxial.

14. The filling system of claim 4, wherein said contact surface comprises a seal against which the container mouth lies during the at least one phase of the filling process.

15. The filling system of claim 1, further comprising
a plurality of filling elements as recited in claim 1, each of which has a return gas pipe, each of said return gas pipes being axially mobile, and
an adjustment device that axially moves the return gas pipes of each of said filling elements.
